(19) United States
(12) Patent Application Publication
(10) Pub. No.: US 2026/0139970 A1
(43) Pub. Date: May 21, 2026

(54) CONTROLLING POWER STATES OF INDUCTIVE SENSOR CIRCUIT UTILIZING CAPACITIVE SENSOR CIRCUIT

(71) Applicant: Microchip Technology Inc., Chandler, AZ (US)

(72) Inventors: Miguel Lomeli, Lake in the Hills, IL (US); Michael Lindfors, Whitefish Bay, WI (US); Andy Appeldorn, Kansas City, MO (US); Mario Falcone, Waterford, WI (US); Ganesh Shaga, Telangana State (IN)

(73) Assignee: Microchip Technology Inc., Chandler, AZ (US)

(21) Appl. No.: 19/451,056

(22) Filed: Jan. 16, 2026

Related U.S. Application Data
(63) Continuation-in-part of application No. 18/443,804, filed on Feb. 16, 2024.

(51) Int. Cl. G01D 5/20; G01D 5/241; H01M 10/42

(52) U.S. Cl. CPC G01D 5/20; G01D 5/241; H01M 10/4264

(57) ABSTRACT

An inductive position sensor with low and high power modes for measuring the position of a movable target. A capacitive sensor circuit detects initial target movement and changes modes of the inductive sensor circuit. A power down state or low power mode conserves battery life. A method for operating an inductive sensor circuit in a first power consumption mode, wherein the inductive sensor circuit senses a target's position, detecting a change of the target's position via a capacitive sensor circuit, changing the inductive winding sensor from the first power consumption mode to a second power consumption mode based on the capacitive sensor circuit detecting a change of the target's position, and operating the inductive sensor circuit in the second power consumption mode, wherein the inductive sensor circuit consumes more power when operating in the second power consumption mode than when operating in the first power consumption mode.

### CONTINUATION STATEMENT

This application is a continuation-in-part of U.S. application Ser. No. 18/443,804, filed Feb. 16, 2024, the entire contents of which are incorporated herein by reference for all purposes.

### TECHNICAL FIELD

The present application relates generally to inductive position sensing. More specifically, some examples relate to low power and high power modes of an inductive sensor circuit for measuring the position of a movable target, without limitation. Additionally, apparatuses and methods are disclosed employing capacitive sensor circuits to detect initial target movement and change modes of the inductive sensor circuit.

### BACKGROUND

A non-contact inductive position sensor may be used to measure a position of a target that is movable relative to the sensor. The target may be used in a number of applications, for example, the target may be a finger trigger to operate a hand-held electric tool, such as a drill or saw. Where it is desirable to allow the operator to control the speed of the electric tool by depressing the finger trigger (short depression for slow speed and long depression for fast speed), the sensor may be used to determine how far the finger trigger is depressed.

If a coil of wire is placed in a changing magnetic field, a voltage will be induced at ends of the coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a target that disturbs a predictably changing magnetic field based on a change in a voltage induced in a coil of wire.

However, the voltage induced at the ends of the coil of wire consumes power. In the context of battery-operated tools and appliances, it is desirable to reduce power consumption to extend battery life.

There is a need for a non-contacting inductive position sensor for measuring the position of a movable target that consumes less power.

### SUMMARY

Aspects provide a power down state or low power mode to conserve battery life, which directly impacts the life span of the batteries, in applications using inductive sensor circuits to determine a target's position.

According to aspects, there is provided a method comprising: operating an inductive sensor circuit in a first power consumption mode, wherein the inductive sensor circuit senses a target's position; detecting a change of the target's position via a capacitive sensor circuit; changing the inductive winding sensor from the first power consumption mode to a second power consumption mode based on the capacitive sensor circuit detecting a change of the target's position; and operating the inductive sensor circuit in the second power consumption mode, wherein the inductive sensor circuit consumes more power when operating in the second power consumption mode than when operating in the first power consumption mode.

Aspects as in the preceding paragraph provide a method, wherein the first power consumption mode comprises a power off condition wherein the inductive sensor circuit consumes no power.

Aspects as in one of the preceding two paragraphs provide a method, wherein detecting a change of the target's position via the capacitive sensor circuit comprises detecting a change of the target's position from a target start position, wherein changing the inductive sensor circuit from the first power consumption mode to the second power consumption mode is based on the capacitive sensor circuit detecting the change of the target's position from the target start position.

Aspects as in one of the preceding three paragraphs provide a method, wherein the capacitive sensor circuit comprises a drive electrode and a sense electrode, wherein the drive electrode is driven to a voltage potential, wherein detecting a change of the target's position via the capacitive sensor circuit comprises detecting a deviation of a characteristic of a signal of the capacitive sensor circuit, wherein the characteristic of the signal deviates when the target changes position relative to the capacitive sensor circuit.

Aspects as in one of the preceding four paragraphs provide a method, comprising: changing the inductive winding sensor to a third power consumption mode based on the capacitive sensor circuit detecting a change of the target's position; and operating the inductive sensor circuit in the third power consumption mode, wherein the inductive sensor circuit consumes more power when operating in the third power consumption mode than when operating in the second power consumption mode.

Aspects as in one of the preceding five paragraphs provide a method, comprising: changing the inductive sensor circuit from the second power consumption mode to the first power consumption mode based on the capacitive sensor circuit detecting a change of the target's position.

Aspects as in one of the preceding six paragraphs provide a method, wherein the inductive sensor circuit comprises a linear inductive position sensor of the target, wherein the target moves linearly.

Aspects as in one of the preceding seven paragraphs provide a method, wherein the inductive sensor circuit comprises a rotational inductive position sensor of the target, wherein the target moves rotationally.

According to aspects, there is provided a device comprising: an inductive sensor circuit to detect a position of a target and to operate in a first power consumption mode and a second power consumption mode, wherein the inductive sensor circuit is to consume more power when operating in the second power consumption mode than when operating in the first power consumption mode; a capacitive sensor circuit to detect a change of the target's position; and a power control circuit to change the inductive sensor circuit from operating in the first power consumption mode to operating in the second power consumption mode based on the capacitive sensor circuit detecting a change of the target's position.

Aspects as in the preceding paragraph provide a device, wherein the first power consumption mode comprises a power off condition wherein the inductive sensor circuit consumes no power.

Aspects as in one of the preceding two paragraphs provide a device, wherein the inductive circuit is to operate in a third power consumption mode based on the capacitive sensor circuit detecting a change of the target's position, wherein the inductive sensor circuit is to consume more power when operating in the third power consumption mode than when operating in the second power consumption mode.

According to aspects, there is provided a system comprising: a target movably positionable between a start position and an end position; an inductive sensor circuit comprising an inductive sensor positioned to detect a position of the target, wherein the inductive sensor circuit is to operate in a first power consumption mode and a second power consumption mode; a capacitive sensor circuit comprising a capacitive sensor positioned to detect a change of the target's position; and a power control circuit to change the inductive sensor circuit from operating in the first power consumption mode to operating in the second power consumption mode based on the capacitive sensor circuit detecting a change of the target's position.

Aspects as in one of the preceding two paragraphs provide a system, wherein the inductive sensor circuit is to consume more power when operating in the second power consumption mode than when operating in the first power consumption mode.

Aspects as in one of the preceding two paragraphs provide a system, wherein the capacitive sensor circuit is to detect a change of the target's position from a target start position, wherein the power control circuit is to change the inductive sensor circuit from the first power consumption mode to the second power consumption mode based on the capacitive sensor circuit detecting the change of the target's position from the target start position.

Aspects as in one of the preceding three paragraphs provide a system, wherein the capacitive sensor circuit comprises a drive electrode and a sense electrode, wherein the capacitive sensor circuit is to detect a deviation of a characteristic of a sense electrode signal, wherein the characteristic of the signal is to deviate when the target changes position relative to the capacitive sensor circuit.

Aspects as in one of the preceding four paragraphs provide a system, wherein the inductive sensor circuit is to operate in a third power consumption mode based on the capacitive sensor circuit detecting a change of the target's position; and wherein the inductive sensor circuit is to consume more power when operating in the third power consumption mode than when operating in the second power consumption mode.

Aspects as in one of the preceding five paragraphs provide a system, wherein the power control circuit is to change the inductive sensor circuit from the second power consumption mode to the first power consumption mode based on the capacitive sensor circuit detecting a change of the target's position.

Aspects as in one of the preceding six paragraphs provide a system, wherein the inductive sensor circuit comprises a linear inductive position sensor of the target, and wherein the target moves linearly.

Aspects as in one of the preceding seven paragraphs provide a system, wherein the inductive sensor circuit comprises a rotational inductive position sensor of the target, and wherein the target moves rotationally.

Aspects as in one of the preceding eight paragraphs provide a system, wherein the power control circuit is to increase power supply to the inductive sensor circuit from a first power consumption mode in which the inductive sensor circuit consumes no power.

### BRIEF DESCRIPTION OF THE DRAWINGS

A more complete understanding of the disclosure and the advantages thereof may be acquired by referring to the following description, taken in conjunction with the accompanying drawings and wherein:

FIGS. 1A and 1B are top-down views of an apparatus comprising a capacitive sensor circuit to detect an initial movement of a target and an inductive sensor circuit for position sensing of the target, wherein the target moves linearly.

FIG. 2 is a top-down view of apparatus of FIGS. 1A and 1B, without the target.

FIG. 3A is a top-down view of the apparatus of FIG. 2, illustrating one or more oscillator coils without the sine and cosine coils or the capacitive sensor circuit.

FIG. 3B is a top-down view of the apparatus of FIG. 2, illustrating the first sense coil comprising sine coil without the one or more oscillator coils, the cosine coil, and the capacitive sensor circuit.

FIG. 3C is a top-down view of the apparatus of FIG. 2, illustrating the second sense coil comprising cosine coil without the one or more oscillator coils, the sine coil, and the capacitive sensor circuit.

FIG. 3D is a top-down view of the apparatus of FIG. 2, illustrating the capacitive sensor circuit system without the one or more oscillator coils, the sine coil, and the cosine coil.

FIG. 4 is a diagram of a capacitive sensor circuit to detect an initial movement of a target and an inductive sensor circuit for position sensing of the target, wherein the target rotates.

FIG. 5 is a diagram of a capacitive sensor circuit to detect an initial movement of a target and an inductive sensor circuit for position sensing of the target, wherein the target rotates.

FIG. 6A is a schematic diagram of sensors circuitry of a linear position sensor and capacitive sensor.

FIG. 6B is a flowchart describing a method of operating an apparatus comprising a capacitive sensor and a linear inductive position sensor.

FIG. 7A is a block diagram of an apparatus having an integrated capacitive sensor to inductive sensors to achieve low power states by enabling and disabling the supply voltage of inductor sensors.

FIG. 7B is a flowchart describing a method of operating an apparatus, for example the apparatus illustrated in FIG. 7A, comprising a capacitive sensor and a linear inductive position sensor.

FIG. 8 is a block diagram of circuitry that, in some examples, may be used to implement various functions, operations, acts, processes, and/or methods disclosed herein.

The drawings accompanying and forming part of this specification are included to depict certain aspects of the disclosure. The reference number for any illustrated element that appears in multiple different figures has the same meaning across the multiple figures, and the mention or discussion herein of any illustrated element in the context of any particular figure also applies to each other figure, if any, in which that same illustrated element is shown. The features illustrated in the drawings are not necessarily drawn to scale. It should be noted that the features illustrated in the drawings are not necessarily drawn to scale.

### DESCRIPTION

According to aspects, there is provided an integrated capacitive sensing to inductive sensors to achieve lower power consumption states by enabling and disabling the supply voltage of inductor sensors. By incorporating the integrated capacitive sensing into inductive sensors, power consumption is reduced and battery life of products is extended.

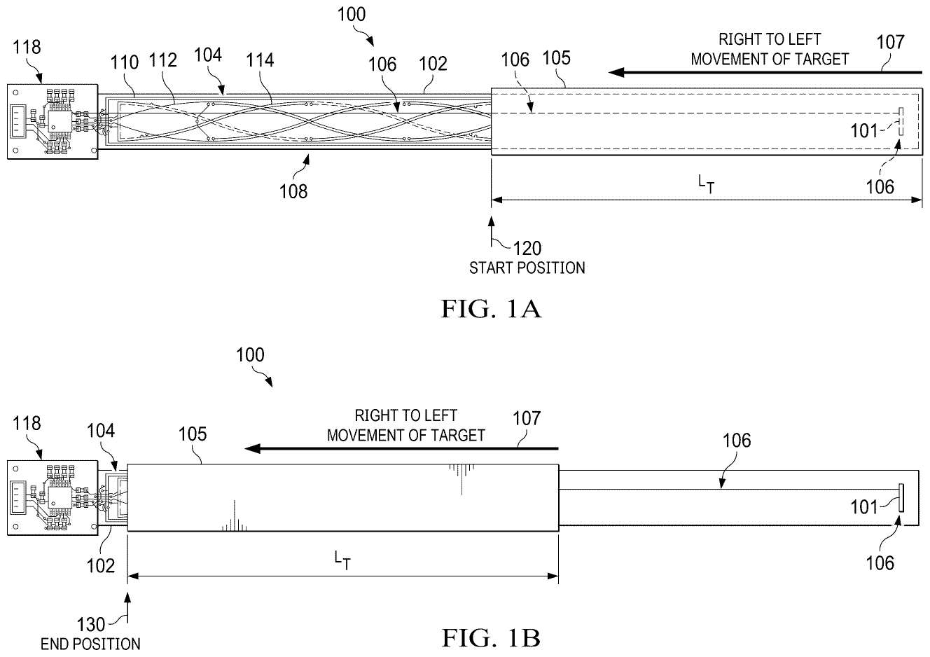

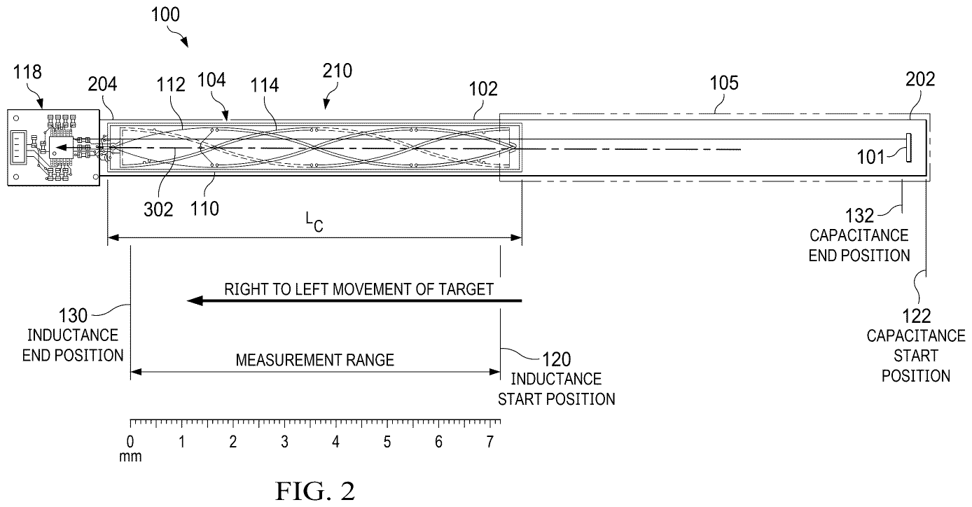

FIGS. 1A and 1B are top-down views of an apparatus 100 comprising a capacitive sensor circuit 106 having a capacitive sensor 101 to detect an initial movement of a target 105 and an inductive sensor circuit 108 for position sensing of the target 105, according to one or more examples of the disclosure. FIG. 2 is a top-down view of apparatus 100 of FIGS. 1A and 1B without the target.

Apparatus 100 comprises a capacitive sensor 101 on, or in, support structure 102 to detect an initial movement of the target 105. The capacitive sensor 101 may be a non-contact device that detects the presence or absence of the target 105. According to one aspect, the capacitive sensor 101 uses the electrical property of capacitance and the change of capacitance based on a change in the electrical field around an active face of the sensor. The capacitive sensor may act like a simple capacitor, wherein a metal electrode in a sensing face of the sensor is electrically connected to a capacitance measurement circuit. The target 105 to be sensed acts as the second plate or electrode of the capacitor. Unlike the inductive sensor circuit 108 that may produce an electromagnetic field, the capacitive sensor circuit 106 may produce an electrostatic field.

Apparatus 100 comprises a support structure 102 and multiple coils 104 on, or in, support structure 102. Multiple coils 104 include one or more oscillator coils 110, a first sense coil comprising a sine coil 112, and a second sense coil comprising a cosine coil 114. One or more oscillator coils 110 (or excitation coils) may be referred to as one or more primary coils, and sine and cosine coils 112 and 114 may be referred to as secondary coils.

Multiple coils 104 may be laid out as conductive traces on, or in, one or more planes or layers of support structure 102. In one or more examples, support structure 102 is or includes a substrate, such as a PCB. In one or more further examples, support structure 102 is or includes at least a two-layered PCB including conductive traces to form the coils. An example layering is illustrated in FIG. 2, where solid coil lines on support structure 102 represent conductive traces on a first layer (e.g., a top layer) of the PCB, dashed coil lines on support structure 102 represent conductive traces on a second layer (e.g., a middle layer) of the PCB, and the capacitive sensor 101 is on a third layer (e.g., a bottom layer). The small circles on support structure 102 are conductive vias to connect the conductive traces to and from the different layers. Alternatively, the system may be a multi-layer board where the cap target can be on any layer.

Apparatus 100 may also include a sensors circuitry 118 to process signals associated with the capacitive sensor 101 for sensing initial movement of target 105 and signals associated with the multiple coils 104 for sensing a position of target 105. In one or more examples, sensors circuitry 118 may be provided in an integrated circuit (IC)

A principal of operation may be that the floating metal target 105 is capacitively coupled to the system's ground. When in the metal target 105 is in the first power consumption mode (OFF position), it is also coupled to the sense electrode of the capacitive sensor 101. When the metal target 105 moves from the OFF position, it moves away from the sense electrode, removing the coupling to the metal target 105 which remains coupled to ground. This changes the capacitance seen by the sensor electrode, which is measured. An alternative is the inverse of this, where OFF position has no target to sensor coupling, and movement of the metal target 105 introduces coupling of the target 105 to the capacitive sensor 101, which changes the capacitance as seen by the sensor electrode.

With reference to FIGS. 1A and 1B, target 105 may have a target body which is generally planar (i.e., in-plane with the page). Target 105 is movably positionable along a longitudinal axis of support structure 102 from a start position 120 to an end position 130. In FIG. 1A, target 105 is shown positioned in start position 120 at a first end (e.g., a right or rightmost end) of support structure 102. In one or more examples, target 105 is movably positioned along the longitudinal axis in a direction 107 (e.g., right-to-left movement) towards a second (opposing) end (e.g., a left or left-most end) of support structure 102. In FIG. 1B, target 105 is shown positioned in end position 130 at the second end of support structure 102.

In FIG. 2, first and second ends 202 and 204 of support structure 102 are designated. The target 105 (shown in dotted lines) is shown in a start position extending from the first end 202 to the oscillator coils 110. The target 105 moves from right to left, in FIG. 2. At the leading edge of the target 105, an inductance start position 120 is indicated, and at the trailing edge of the target 105, a capacitance start position 122 is indicated. As the target 105 moves from right to left, the trailing edge of the target 105 moves off of the capacitive sensor 101 to a capacitive end position 132. As the target 105 moves from right to left, the leading edge of the target 105 moves over the one or more oscillator coils 110, the sine coils 112, and the cosine coils to the inductance end position 130. A longitudinal axis 302 of support structure 102 along which the target 105 is movably positionable is also indicated. As shown, the length of the support structure 102 between the capacitance start/end positions 122 and 132 is much shorter than the length of the support structure 102 between the inductance start/end positions 120 and 130.

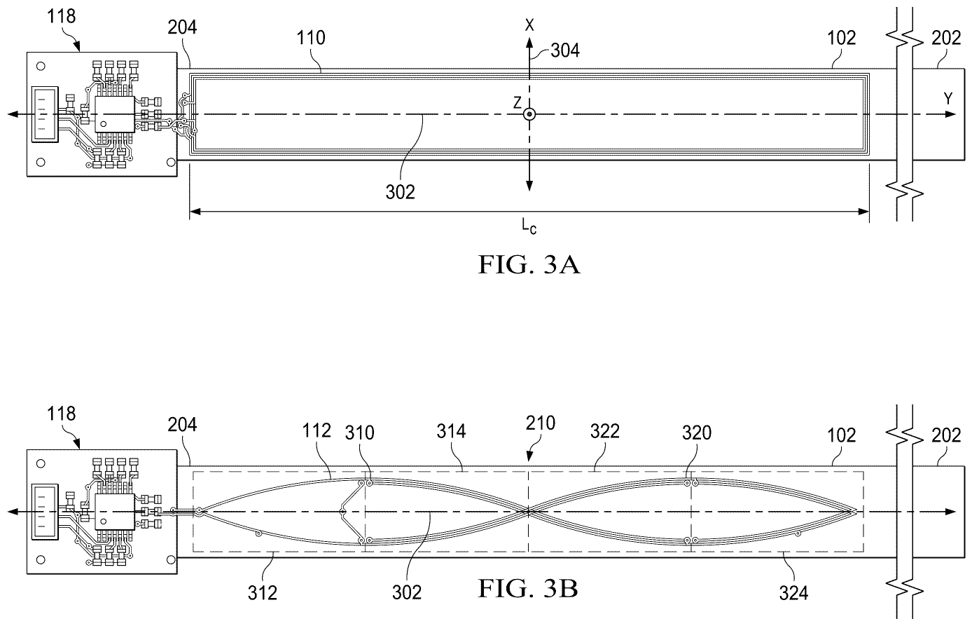

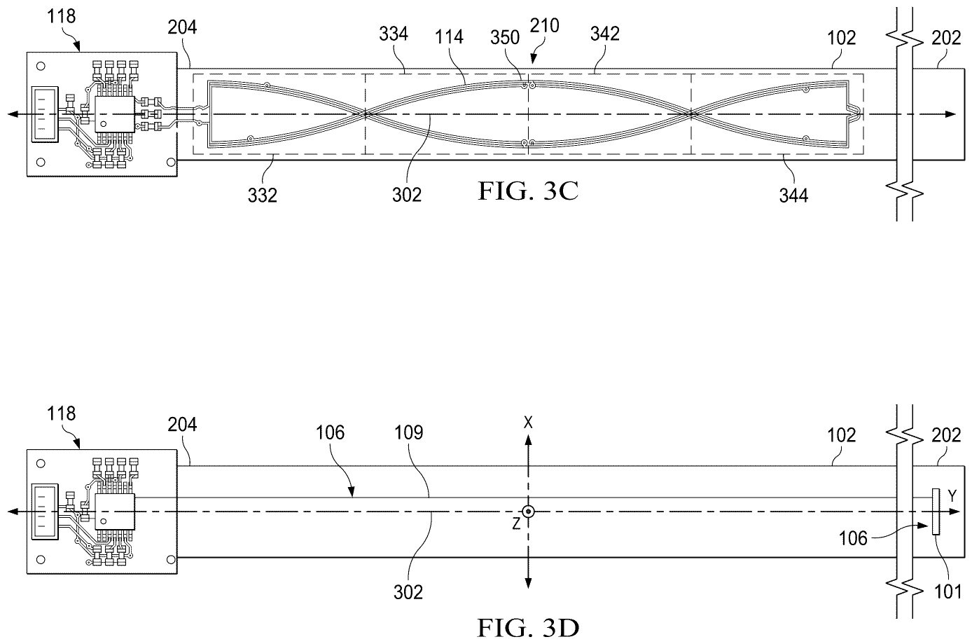

FIGS. 3A-3C are top-down views of the apparatus of FIG. 2, each figure illustrating a respective one of the sensor coils with the other coils removed. More particularly, FIG. 3A is a top-down view of the apparatus of FIG. 2, illustrating one or more oscillator coils 110 without the sine and cosine coils or the capacitive sensor. FIG. 3B is a top-down view of the apparatus of FIG. 2, illustrating the first sense coil comprising sine coil 112 without the one or more oscillator coils, the cosine coil, and the capacitive sensor. FIG. 3C is a top-down view of the apparatus of FIG. 2, illustrating the second sense coil comprising cosine coil 114 without the one or more oscillator coils, the sine coil, and the capacitive sensor. FIG. 3D is a top-down view of the apparatus of FIG. 2, illustrating the capacitive sensor 101 without the one or more oscillator coils 110, the sine coil 112, and the cosine coil 114.

With reference to FIG. 3A, one or more oscillator coils 110 are shown to form a generally rectangular shape. Longitudinal axis 302 of support structure 102 is indicated along the Y-axis of the coordinate system, shown together with a transverse axis 304 of support structure 102 along the X-axis, and with the Z-axis extending perpendicularly out of the plane of the page. With reference to FIG. 3B, the first sense coil comprising sine coil 112 is arranged about longitudinal axis 302 of support structure 102, and has opposing ends between opposing ends (e.g., first and second ends 202 and 204) of the support structure 102. With reference to FIG. 3C, the second sense coil comprising cosine coil 114 is also arranged about longitudinal axis 302 of support structure 102, and has opposing ends between the opposing ends of support structure 102 (e.g., first and second ends 202 and 204). With reference to FIGS. 2 and 3A, one or more oscillator coils 110 are arranged around the sine and the cosine coils.

In FIG. 3B, sine coil 112 generally forms a sine wave pattern and defines at least a first lobe 310 (e.g., a positive lobe) and a second lobe 320 (e.g., a negative lobe). First lobe 310 of sine coil 112 may comprise first lobe portions 312 and 314 (e.g., first and second half lobes, respectively), and second lobe 320 of sine coil 112 may comprise second lobe portions 322 and 324 (e.g., also first and second half lobes, respectively). First lobe portion 312 and second lobe portion 324 may be referred to as end-side lobe portions (which are toward first and second ends 202 and 204, respectively), whereas first lobe portion 314 and second lobe portion 322 may be referred to as middle-side lobe portions (which are toward a middle 210 of support structure 102). More particularly, sine coil 112 of FIG. 3B may be defined by one or more first segments having the shape of a sine function, sin x, over a 360° Cycle starting at 0° (e.g., in a forward path), and one or more second segments having the shape of another sine function, −sin x, over a 360° Cycle starting at 0° (e.g., in a return path). Second ends of the one or more first and second segments of sine coil 112 are electrically connected to each other substantially at or near first end 202 of support structure 102 at longitudinal axis 302 (for the return path), and first ends of the one or more first and the second segments of sine coil 112 may be electrically connected to each other substantially at or near second end 204 of support structure 102 at longitudinal axis 302 for respective ones of one or more turns of the sine coil.

In FIG. 3C, cosine coil 114 generally forms a cosine wave pattern and defines first lobe portions 332 and 334 substantially coextensive with first lobe 310 of sine coil 112, and second lobe portions 342 and 344 substantially coextensive with second lobe 320 of sine coil 112. At the middle 210 of support structure 102, cosine coil 114 defines a lobe 350 (e.g., a negative lobe) from first lobe portion 334 (e.g., a first half lobe) and second lobe portion 342 (e.g., a second half lobe). Cosine coil 114 of FIG. 3C may be defined by one or more first segments having the shape of a cosine function, cos x, over a 360° Cycle starting at 0° (e.g., in a forward path), and one or more second segments having the shape of another cosine function, −cos x, over a 360° Cycle starting at 0° (e.g., in a return path). Second ends of the one or more first and second segments of cosine coil 114 are electrically connected to each other substantially at or near second end 204 of support structure 102 (for the return path), and first ends of the one or more first and second segments of cosine coil 114 may be electrically connected to each other substantially at or near second end 204 of support structure 102 for respective ones of one or more turns of the cosine coil.

In FIG. 3D, the capacitive sensor 101 is positioned near first end 202 of support structure 102 along the longitudinal axis 302. A capacitance trace 109 connects the capacitive sensor 101 to the sensors circuitry 118, and collectively comprises a capacitive circuit. The capacitive sensing may be done in a separate chip or in the same chip.

The operation of the apparatus may be described, with reference to FIGS. 1A, 1B, 2, and 3A-3C. The apparatus may initially be in a lower power consumption mode in which only the capacitive sensor circuit 106 and associated circuitry are powered ON, wherein the remaining sensors and circuitry are powered OFF. When the target 105 is initially moved from its start position 120 toward its end position 130, the capacitive sensor 101 of the capacitive sensor circuit 106 senses that the target 105 is proximate and sends a signal to the sensors circuitry 118. A power control circuit switches the apparatus to a higher power mode and powers ON the remaining sensors and associated circuitry. In particular, the one or more oscillator coils 110 are excited with a relatively high frequency signal (e.g., 5 MHz, without limitation) from sensors circuitry 118 to generate a varying magnetic field. The magnetic fields couple onto sine and cosine coils 112 and 114 to produce first and second sense signals, respectively. The first and the second sense signals may be cosine and sine signals, which may be generally close to ideal cosine and sine waveforms. Thus, the coupled signals may be phase-shifted by 90°, where sine coil 112 exhibits a cosine profile and cosine coil 114 exhibits a sine profile. Sine coil 112 is referred to herein using the term “sine” and cosine coil 114 is referred to herein using the term “cosine” to differentiate between the respective sense coils, and because of the physical coil waveform appearance of the respective sense coils on, or in, support structure 102. However, alternative terminology may be utilized, where sine coil 112 is instead referred to using the term “cosine” and cosine coil 114 is instead referred to using the term “sine,” because of the resulting waveforms produced in the respective sense coils.

Meanwhile, target 105 (e.g., a metal target) may be positioned over multiple coils 104 of inductive position sensor 108, and set at a generally fixed distance (i.e., along the Z-axis of the coordinate system in FIG. 3A) from the multiple coils referred to as an airgap. Target 105 will disturb the generated magnetic field. When target 105 is moved, it creates modulated sine and cosine waveforms which are received at the sensors circuitry 118. The modulated sine and cosine signals may be de-modulated for generating first and second voltage position signals associated with the position of target 105. When a processor is included in the IC, the first and second voltage position signals may be used to calculate the position of target 105, for example, by taking an arctan 2 function of the ratio of the signals.

When the target 105 returns to the start position 120 (see FIG. 2), the apparatus may be made to again be in the lower power mode, wherein the capacitive sensor circuit 106 and associated circuitry are powered ON and the remaining sensors and circuitry are powered OFF. The apparatus may remain in the low power mode until the target 105 is initially moved from its start position 120 toward its end position 130, at which time the capacitive sensor circuit 106 senses that the target 105 is coupled to capacitive sensors and sends a signal to the sensors circuitry 118. In the low power mode, the apparatus consumes less energy than in the high power mode.

Target 105 may be made of a conductive material, such as a non-magnetic conductive metal or metal alloy, without limitation. In one or more examples, the non-magnetic conductive metal or metal alloy may be or include copper or aluminum. In one or more other examples, target 105 may be made of a magnetic conductive metal or metal alloy, such as carbon steel or ferritic stainless steel, without limitation. Here, an oscillator or excitation circuitry may generate an excitation signal within a certain range of frequencies (e.g., 1-6 MHz, without limitation) that magnetic domains of the magnetic conductive metals or metal alloys will not react to.

In many applications, the target 105 has a relatively short length which is substantially less than the measurement range that extends between the opposing ends of the sine or cosine coil. As a result, the target has an area for magnetic field disturbance that remains the same as it is movably positioned across the measurement range of the sensor. In one or more examples of FIGS. 1A, 1B and 2, target 105 has a length L_{T} that is greater than or equal to a measurement range of the sensor, which extends generally from start position 120 to end position 130 of the sensor. In one or more examples, target 105 has a length L_{T} that is greater than or equal to the coil length L_{C}, or greater than or equal to at least 90 percent of the coil length L_{C}. The measurement range may extend substantially between the opposing ends of sine coil 112 or cosine coil 114 over a coil length L_{C} (FIG. 2), or over at least 90 percent of the coil length L_{C}. In FIG. 2, it is shown that the measurement range of apparatus 100 may be about 72 millimeters (mm), without limitation.

Given the above, target 105 has an area for magnetic field disturbance that increases as it is movably positioned across the measurement range of the sensor. For example, in start position 120, target 105 may disturb substantially little or none of a magnetic coupling between one or more oscillator coils 110 and sine and cosine coils 112 and 114. In the middle 210 of the measurement range, target 105 may disturb substantially an entire half of the magnetic coupling between one or more oscillator coils 110 and sine and cosine coils 112 and 114. In end position 130, target 105 may disturb substantially most or an entirety of the magnetic coupling between one or more oscillator coils 110 and sine and cosine coils 112 and 114.

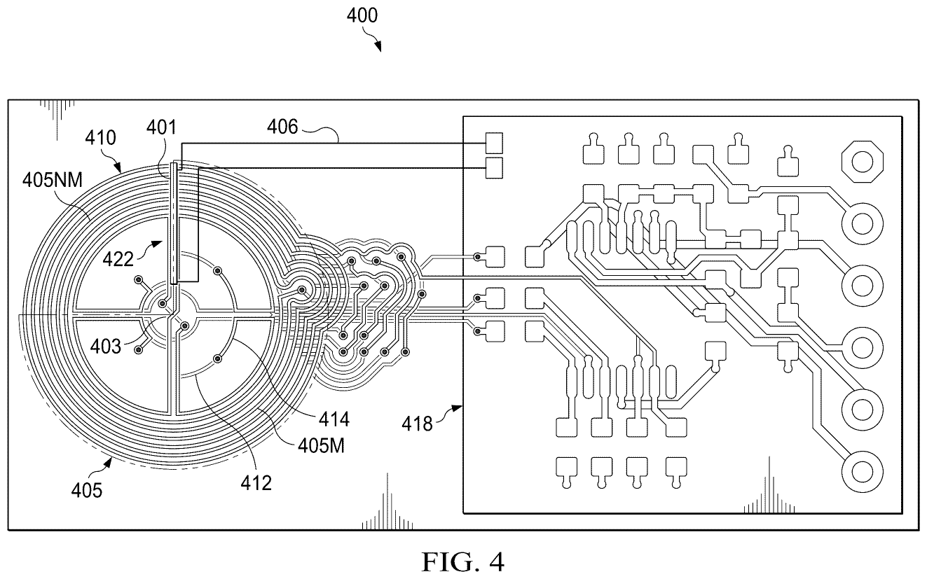

FIG. 4 shows a diagram of a rotational sensor. The rotational sensor 400 may have a target 405 which is generally disk-shaped (i.e., in-plane with the page). The target 405 may have a metal portion 405M that comprises three quadrants or 270° and a nonmetal portion 405NM that comprises one quadrant or 90°. Target 405 is rotatably positionable around a central axis 403 (perpendicular to the page). In FIG. 4, target 405 is shown positioned in a start position, wherein a leading edge 422 of the metal portion 405M of the target 405 is positioned adjacent a capacitive sensor 401. The apparatus may initially be in a low power mode in which only the capacitive sensor circuit 406 and associated circuitry are powered ON, wherein the remaining sensors and circuitry are powered OFF. When the target 405 is initially moved from its start position toward the capacitive sensor 401, the capacitive sensor 401 of the capacitive sensor circuit 406 senses the target 405 and sends a signal to the sensors circuitry 418. A power control circuit switches the apparatus to the high power mode and powers ON the remaining sensors and associated circuitry. In particular, the one or more oscillator coils 410 are excited with a relatively high frequency signal (e.g., 5 MHz, without limitation) from sensors circuitry 418 to generate a varying magnetic field. The magnetic fields couple onto sine and cosine coils 412 and 414 to produce first and second sense signals, respectively. As the target 405 rotates, its angular position is determined by the position of the nonmetal portion 405NM relative to the sine and cosine coils 412 and 414.

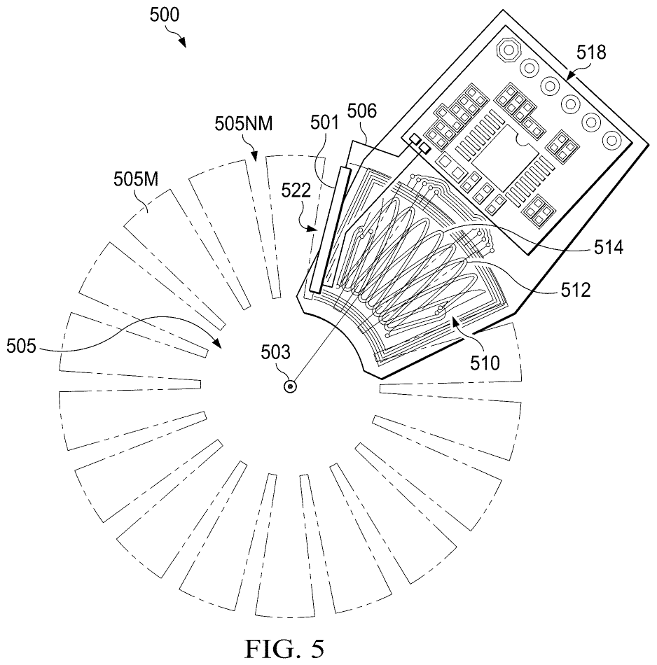

FIG. 5 shows a schematic diagram of a rotational sensor. The rotational sensor 500 may have a target 505 which is generally disk-shaped (i.e., in-plane with the page). The target 505 may have a plurality of metal blades 505M and a plurality of nonmetal blades 505NM, wherein the blades are alternately positioned around the target 505. Target 505 is rotatably positionable around a central axis 503 (perpendicular to the page). In FIG. 5, target 505 is shown positioned in a start position, wherein a leading edge 522 of a metal blade 505M of the target 505 is positioned adjacent a capacitive sensor 501. The apparatus may initially be in a low power mode in which only the capacitive sensor circuit 506 and associated circuitry are powered ON, wherein the remaining sensors and circuitry are powered OFF. When the target 505 is initially moved from its start position toward the capacitive sensor 501, the capacitive sensor 501 of the capacitive sensor circuit 506 senses that the target 505 is proximate and sends a signal to the sensors circuitry 518. A power control circuit switches the apparatus to a high power mode and powers ON the remaining sensors and associated circuitry. In particular, the one or more oscillator coils 510 are excited with a relatively high frequency signal (e.g., 5 MHz, without limitation) from sensors circuitry 518 to generate a varying magnetic field. The magnetic fields couple onto sine and cosine coils 512 and 514 to produce first and second sense signals, respectively. As the target 505 rotates, its angular position is determined by the position of the nonmetal blades 505NM relative to the sine and cosine coils 512 and 514.

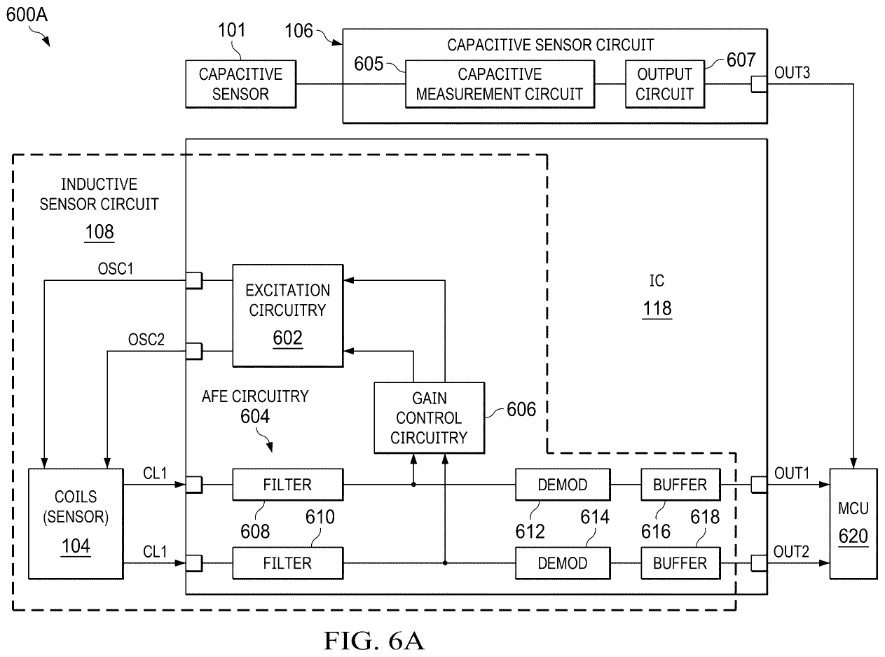

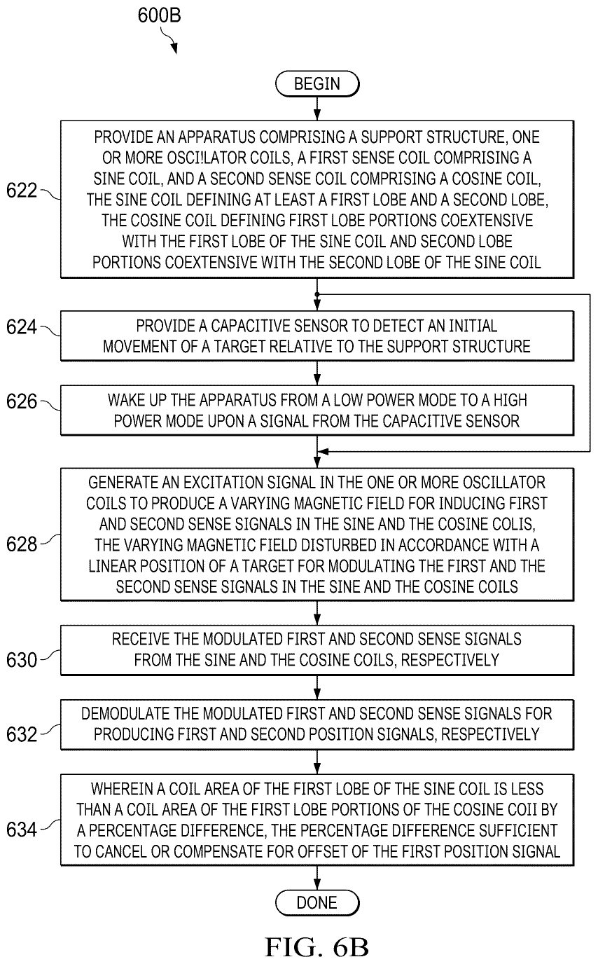

FIG. 6A is a schematic diagram 600A of sensors circuitry 118 of a capacitive sensor circuit 106 and an inductive sensor circuit 108 according to one or more examples. In one or more examples, sensors circuitry 118 and capacitive sensor circuit 106 may be contained (in total or in part) in an IC or multiple ICs. In one or more examples, capacitive sensor circuit 106 includes a capacitance measurement circuit 605 and an output circuit 607. The capacitance between the target 105 and the capacitive sensor 101 forms a part of the capacitive sensor circuit 106. As the target 105 moves away from or towards the capacitive sensor 101, it detects the change from a coupled to uncoupled, as well as uncoupled to coupled state with the moving target where the capacitance increases or decreases until the change reaches a threshold level and activates an output. The capacitive measurement circuit 605 compares the measurement output to the threshold level to determine whether the target 105 is no longer proximate the capacitive sensor 101, which indicates that the target 105 has initiated movement from its starting position toward its end position. If yes, the capacitive measurement circuit 605 provides a signal to the output circuit 607, which then provides OUT3 signal to the MCU 620. The sensitivity or the threshold level of the oscillator of the capacitive sensor may be adjusted. If the sensor does not have an adjustment method then the sensor may physically be moved for sensing the target correctly. Movement can be detected by the changing sensor capacitance from moving from coupled to uncoupled, as well as uncoupled to coupled. Target movement can be detected by, the target 105 being normally coupled to the ground (GND) electrode, and moving between being coupled and decoupled from the capacitance sensor electrode. As well as the target 105 being normally coupled to the capacitance sensor electrode, and moving between being coupled and decoupled from the ground electrode.

In one or more examples, sensors circuitry 118 includes an excitation circuitry 602, an analog front-end (AFE) circuitry 604, and a gain control circuitry 606 of the inductive sensor circuit 108. AFE circuitry 604 may include, for a modulated first sense signal from the sine coil (at input CL1), a filter 608 (e.g., an EMI filter), a demodulator 612, and a buffer 614. AFE circuitry 604 may also include, for a modulated second sense signal from the cosine coil (at input CL2), a filter 610 (e.g., an EMI filter), a demodulator 614, and a buffer 618. First and second position signals (e.g., indicating a position of the target) may be provided at outputs OUT1 and OUT2 of sensors circuitry 118. Gain control circuitry 606 may be coupled to the signal paths (e.g., prior to signal demodulation) and to excitation circuitry 602. Gain control circuitry 606 may be provided to adjust the amplitude of excitation signals from excitation circuitry 602 responsive to changes in the received sense signals (e.g., adjustments based on an airgap variation between the target and the coils).

In general, the first and the second position signals are determined at least partially based on the modulated first and the second sense signals from the sine and the cosine coils (e.g., CL1, CL2), respectively. More specifically, excitation circuitry 602 is to generate one or more excitation signals in the one or more oscillator coils (e.g., at OSC1, OSC2) to produce a varying magnetic field for inducing the first and the second sense signals in the sine and cosine coils, respectively. The varying magnetic field is disturbed in accordance with a linear position of the target for modulating the first and the second sense signals in the sine and the cosine coils. The modulated first and second sense signals are received from the sine and the cosine coils at inputs (e.g., CL1, CL2). AFE circuitry 604 receives and processes these signals. The modulated first sense signal (at CL1) is filtered through filter 608, demodulated by demodulator 612 to produce the first position signal, and outputted to the output OUT1 through buffer 616. The modulated second sense signal from the cosine coil (at CL2) is filtered through filter 610, demodulated by demodulator 614 to produce the second position signal, and outputted to the output OUT2 through buffer 618.

In one or more examples, when sensors circuitry 118 includes a processor (e.g., a central processing unit (CPU)), sensors circuitry 118 may also calculate the linear position of the target at least partially based on the first and the second positions signals (e.g., based on an arctan 2 function). In one or more other examples, a microcontroller unit (MCU) 620 or an electronic control unit (ECU) may receive the first and the second positions signals at the outputs OUT1 and OUT2, respectively, and calculate the linear position of the target at least partially based on the first and the second positions signals (e.g., based on an arctan 2 function).

In one or more examples, the one or more oscillator coils include a first oscillator coil and a second oscillator coil, and excitation circuitry 602 is to generate a first excitation signal in the first oscillator coil and a second excitation signal in the second oscillator coil, for producing the varying magnetic field for inducing first and second sense signals in the sine and the cosine coils, respectively. In one or more examples, the second excitation signal is substantially 180° out-of-phase with the first excitation signal.

FIG. 6B is a flowchart describing a method 600B of operating an apparatus comprising a linear inductive position sensor, according to one or more examples. At an act 622 of FIG. 6B, an apparatus is provided. The apparatus comprises a support structure, the one or more oscillator coils, a first sense coil comprising a sine coil, and a second sense coil comprising a cosine coil. The sine coil defines at least a first lobe and a second lobe. The cosine coil defines first lobe portions substantially coextensive with the first lobe of the sine coil and second lobe portions substantially coextensive with the second lobe of the sine coil.

At act 624, a capacitive sensor is provided to detect an initial movement of a target relative to the support structure. At act 626, the apparatus is woken up from a low power mode to a high power mode upon a signal from the capacitive sensor.

At acts 628, 630, and 632 of FIG. 4B, first and second position signals indicating a position of a target are determined at least partially based on first and second sense signals from the sine and the cosine coils, respectively. More specifically, at an act 628, an excitation signal in the one or more oscillator coils is generated to produce a varying magnetic field for inducing the first and the second sense signals in the sine and cosine coils, respectively. The varying magnetic field is disturbed in accordance with a linear position of the target for modulating the first and the second sense signals in the sine and the cosine coils. At an act 630, the modulated first and second sense signals are received from the sine and the cosine coils, respectively. At an act 632, the modulated first and second sense signals are demodulated to produce the first and the second position signals, respectively.

As described at a block 634 of FIG. 4B, a coil area of the first lobe of the sine coil is less than a coil area of the first lobe portions of the cosine coil by a percentage difference, where the percentage difference of the first lobe is sufficient to cancel or compensate for an offset of the first position signal. In one or more examples, the percentage difference within a range of about 20 to 30 percent. In one or more examples, the percentage difference is about 25 percent.

In one or more examples, a position voltage of the target is determined based on the first and the second position signals (e.g., calculated based on an arctan 2 function of the ratio of the signals). The position voltage may exhibit an improved linearity over the measurement range from the start position to the end position.

In one or more examples of method 600B of FIG. 6B, the target has a length that is greater than or equal to a measurement range extending substantially between opposing ends of the sine or the cosine coil. The target is movably positionable along the longitudinal axis of the support structure from a start position to an end position. In the start position, the target is to disturb substantially little or none of a magnetic coupling between the one or more oscillator coils and the sine and the cosine coils. In a middle position, the target is to disturb substantially an entire half of the magnetic coupling between the one or more oscillator coils and the sine and the cosine coils. In the end position, the target is to disturb substantially most or an entirety of the magnetic coupling between the one or more oscillator coils and the sine and the cosine coils. For offset compensation, the first lobe of the sine coil may be located at a first end of the support structure at or towards the end position for the target.

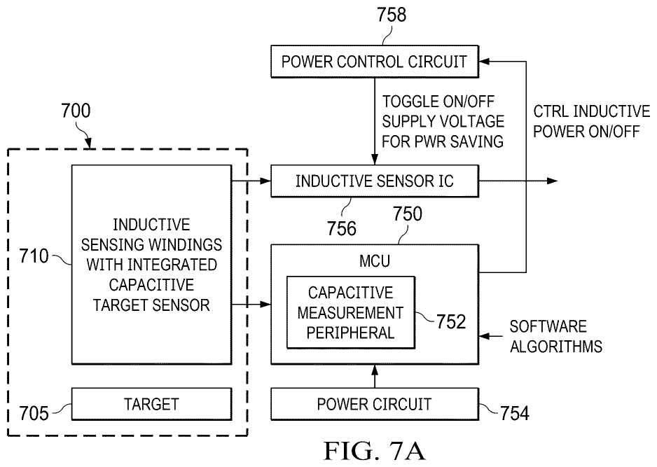

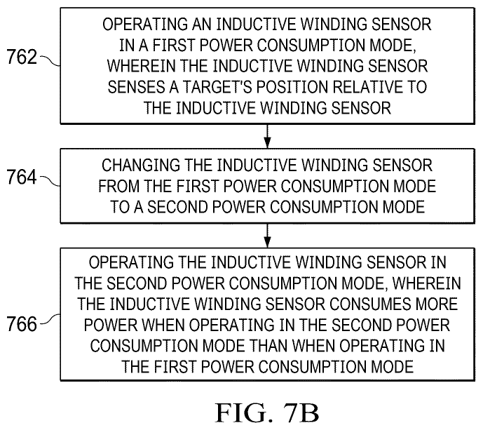

FIG. 7A is a block diagram of an apparatus having integrated capacitive and inductive sensors to achieve low power states by enabling and disabling the supply voltage of inductor sensors. By incorporating the integrated capacitive sensing into inductive sensors, power consumption is reduced and battery life of products is extended. The apparatus 700 includes inductive sensing windings with integrated capacitive target sensor 710. The apparatus 700 also includes a target 705. A microcontroller 750 has a capacitive measurement peripheral 752, which may be programmed with software algorithms. The capacitive measurement peripheral 752 receives a signal from the capacitive target sensor of the inductive sensing windings with integrated capacitive target sensor 710. A first power circuit 754 supplies power to the microcontroller 750 and the capacitive measurement peripheral 752. An inductive sensor integrated circuit 756 receives a signal from the inductive sensing windings of the inductive sensing windings with integrated capacitive target sensor 710 and provides an output indicative of the target position. The inductive sensor integrated circuit 756 is powered by a second power control circuit 758. The second power control circuit 758 receives a control inductive power ON/OFF signal from the microcontroller 750, which may be used to switch the apparatus between a low power mode and high power mode. In the low power mode, the second power control circuit 758 does not provide power to the inductive sensor IC and related sensors and circuitry. In the high power mode, the second power control circuit 758 does provide power to the inductive sensor IC and related sensors and circuitry. The second power control circuit 758 may toggle ON/OFF supply voltage to the inductive sensor integrated circuit 756 for power savings.

FIG. 7B is a flowchart describing a method of operating an apparatus, for example the apparatus illustrated in FIG. 7A, comprising a capacitive sensor and a linear inductive position sensor. An inductive winding sensor is operated 762 in a first power consumption mode, wherein the inductive winding sensor senses a target's position relative to the inductive winding sensor. The inductive winding sensor is changed 764 from the first power consumption mode to a second power consumption mode. The inductive winding sensor is operated 766 in the second power consumption mode, wherein the inductive winding sensor consumes more power when operating in the second power consumption mode than when operating in the first power consumption mode.

An inductive sensor circuit or a capacitive sensor circuit may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. An inductive sensor circuit or a capacitive sensor circuit may be implemented by instructions for execution by a processor through, for example, a function, application programming interface (API) call, script, program, compiled code, interpreted code, binary, executable, executable file, firmware, object file, container, assembly code, or object. For example, an inductive sensor circuit or a capacitive sensor circuit may be implemented by instructions stored in a non-transitory medium such as a memory that, when loaded and executed by a processor such as a CPU (or any other suitable process), cause the functionality of inductive sensor circuits or capacitive sensor circuits described herein.

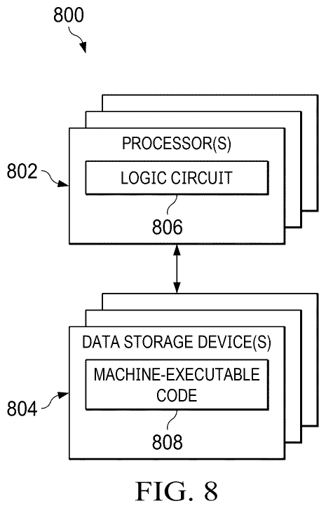

FIG. 8 is a block diagram of circuitry 800 that, in some examples, may be used to implement various functions, operations, acts, processes, and/or methods disclosed herein. The circuitry 800 includes one or more processors 802 (sometimes referred to herein as “processors 802”) operably coupled to one or more data storage devices (sometimes referred to herein as “storage 804”). The storage 804 includes machine-executable code 808 stored thereon and the processors 802 include a logic circuit 806. The machine-executable code 808 includes information describing functional elements that may be implemented by (e.g., performed by) the logic circuit 806. The logic circuit 806 is adapted to implement (e.g., perform) the functional elements described by the machine-executable code 808. The circuitry 800, when executing the functional elements described by the machine-executable code 808, should be considered as special purpose hardware for carrying out functional elements disclosed herein. In some examples, the processors 802 may perform the functional elements described by the machine-executable code 808 sequentially, concurrently (e.g., on one or more different hardware platforms), or in one or more parallel process streams.

When implemented by logic circuit 806 of the processors 802, the machine-executable code 808 adapts the processors 802 to perform operations of examples disclosed herein. For example, the machine-executable code 808 may be to adapt the processors 802 to perform at least a portion or a totality of operations associated with the apparatus 100 for capacitive sensing and inductive linear-position sensing according to one or more examples, including acts in a method of waking an apparatus from a low power mode to a high power mode and operating a linear inductive position sensor (e.g., method 600B of FIG. 6B, method of FIG. 7B).

The processors 802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 808 (e.g., software code, firmware code, hardware descriptions) related to examples of the present disclosure. It is noted that a general-purpose processor (may also be referred to herein as a host processor or simply a host) may be a microprocessor, but in the alternative, the processors 802 may include any conventional processor, controller, microcontroller, or state machine. The processors 802 may also be implemented as a combination of computing devices, such as a combination of a DSP and a microprocessor, a plurality of microprocessors, one or more microprocessors in conjunction with a DSP core, or any other such configuration.

In some examples the storage 804 includes volatile data storage (e.g., random-access memory (RAM)), non-volatile data storage (e.g., Flash memory, a hard disc drive, a solid-state drive, erasable programmable read-only memory (EPROM), etc.). In some examples the processors 802 and the storage 804 may be implemented into a single device (e.g., a semiconductor device product, a system on chip (SOC), etc.). In some examples the processors 802 and the storage 804 may be implemented into separate devices.

In some examples the machine-executable code 808 may include computer-readable instructions (e.g., software code, firmware code). By way of non-limiting example, the computer-readable instructions may be stored by the storage 804, accessed directly by the processors 802, and executed by the processors 802 using at least the logic circuit 806. Also by way of non-limiting example, the computer-readable instructions may be stored on the storage 804, transferred to a memory device (not shown) for execution, and executed by the processors 802 using at least the logic circuit 806. Accordingly, in some examples the logic circuit 806 includes electrically configurable logic circuit 806.

In some examples the machine-executable code 808 may describe hardware (e.g., circuitry) to be implemented in the logic circuit 806 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 806 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 808 may include an HDL, an RTL, a GL description, a mask level description, other hardware description, or any combination thereof.

In examples where the machine-executable code 808 includes a hardware description (at any level of abstraction), a system (not shown, but including the storage 804) may be to implement the hardware description described by the machine-executable code 808. By way of non-limiting example, the processors 802 may include a programmable logic device (e.g., an FPGA or a PLC) and the logic circuit 806 may be electrically controlled to implement circuitry corresponding to the hardware description into the logic circuit 806. Also, by way of non-limiting example, the logic circuit 806 may include hard-wired logic manufactured by a manufacturing system (not shown, but including the storage 804) according to the hardware description of the machine-executable code 808.

Regardless of whether the machine-executable code 808 includes computer-readable instructions or a hardware description, the logic circuit 806 is adapted to perform the functional elements described by the machine-executable code 808 when implementing the functional elements of the machine-executable code 808. It is noted that although a hardware description may not directly describe functional elements, a hardware description indirectly describes functional elements that the hardware elements described by the hardware description are capable of performing.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

Although examples have been described above, other variations and examples may be made from this disclosure without departing from the spirit and scope of these disclosed examples.

What is claimed is:

1. A method comprising:
operating an inductive sensor circuit in a first power consumption mode, wherein the inductive sensor circuit senses a target's position;
detecting a change of the target's position via a capacitive sensor circuit;
changing the inductive winding sensor from the first power consumption mode to a second power consumption mode based on the capacitive sensor circuit detecting a change of the target's position; and
operating the inductive sensor circuit in the second power consumption mode, wherein the inductive sensor circuit consumes more power when operating in the second power consumption mode than when operating in the first power consumption mode.

2. The method as claimed in claim 1, wherein the first power consumption mode comprises a power off condition wherein the inductive sensor circuit consumes no power.

3. The method as claimed in claim 1, wherein detecting a change of the target's position via the capacitive sensor circuit comprises detecting a change of the target's position from a target start position, wherein changing the inductive sensor circuit from the first power consumption mode to the second power consumption mode is based on the capacitive sensor circuit detecting the change of the target's position from the target start position.

4. The method as claimed in claim 1, wherein the capacitive sensor circuit comprises a drive electrode and a sense electrode, wherein detecting a change of the target's position via the capacitive sensor circuit comprises detecting a deviation of a characteristic of a signal of the capacitive sensor circuit, wherein the characteristic of the signal deviates when the target changes position relative to the capacitive sensor circuit.

5. The method as claimed in claim 1, comprising:
changing the inductive winding sensor to a third power consumption mode based on the capacitive sensor circuit detecting a change of the target's position; and
operating the inductive sensor circuit in the third power consumption mode, wherein the inductive sensor circuit consumes more power when operating in the third power consumption mode than when operating in the second power consumption mode.

6. The method as claimed in claim 1, comprising: changing the inductive sensor circuit from the second power consumption mode to the first power consumption mode based on the capacitive sensor circuit detecting a change of the target's position.

7. The method as claimed in claim 1, wherein the inductive sensor circuit comprises a linear inductive position sensor of the target, wherein the target moves linearly.

8. The method as claimed in claim 1, wherein the inductive sensor circuit comprises a rotational inductive position sensor of the target, wherein the target moves rotationally.

9. A device comprising:
an inductive sensor circuit to detect a position of a target and to operate in a first power consumption mode and a second power consumption mode, wherein the inductive sensor circuit is to consume more power when operating in the second power consumption mode than when operating in the first power consumption mode;
a capacitive sensor circuit to detect a change of the target's position; and
a power control circuit to change the inductive sensor circuit from operating in the first power consumption mode to operating in the second power consumption mode based on the capacitive sensor circuit detecting a change of the target's position.

10. The device as claimed in claim 9, wherein the first power consumption mode comprises a power off condition wherein the inductive sensor circuit consumes no power.

11. The device as claimed in claim 9, wherein the inductive circuit is to operate in a third power consumption mode based on the capacitive sensor circuit detecting a change of the target's position, wherein the inductive sensor circuit is to consume more power when operating in the third power consumption mode than when operating in the second power consumption mode.

12. A system comprising:
a target movably positionable between a start position and an end position;
an inductive sensor circuit comprising an inductive sensor positioned to detect a position of the target, wherein the inductive sensor circuit is to operate in a first power consumption mode and a second power consumption mode;
a capacitive sensor circuit comprising a capacitive sensor positioned to detect a change of the target's position; and
a power control circuit to change the inductive sensor circuit from operating in the first power consumption mode to operating in the second power consumption mode based on the capacitive sensor circuit detecting a change of the target's position.

13. The system as claimed in claim 12, wherein the inductive sensor circuit is to consume more power when operating in the second power consumption mode than when operating in the first power consumption mode.

14. The system as claimed in claim 12, wherein the capacitive sensor circuit is to detect a change of the target's position from a target start position, wherein the power control circuit is to change the inductive sensor circuit from the first power consumption mode to the second power consumption mode based on the capacitive sensor circuit detecting the change of the target's position from the target start position.

15. The system as claimed in claim 12, wherein the capacitive sensor circuit comprises a drive electrode and a sense electrode, wherein the capacitive sensor circuit is to detect a deviation of a characteristic of a sense electrode signal, wherein the characteristic of the signal is to deviate when the target changes position relative to the capacitive sensor circuit.

16. The system as claimed in claim 12, wherein the inductive sensor circuit is to operate in a third power consumption mode based on the capacitive sensor circuit detecting a change of the target's position; and wherein the inductive sensor circuit is to consume more power when operating in the third power consumption mode than when operating in the second power consumption mode.

17. The system as claimed in claim 12, wherein the power control circuit is to change the inductive sensor circuit from the second power consumption mode to the first power consumption mode based on the capacitive sensor circuit detecting a change of the target's position.

18. The system as claimed in claim 12, wherein the inductive sensor circuit comprises a linear inductive position sensor of the target, and wherein the target moves linearly.

19. The system as claimed in claim 12, wherein the inductive sensor circuit comprises a rotational inductive position sensor of the target, and wherein the target moves rotationally.

20. The system as claimed in claim 12, wherein the power control circuit is to increase power supply to the inductive sensor circuit from a first power consumption mode in which the inductive sensor circuit consumes no power.
